(19) United States
(12) Patent Application Publication
(10) Pub. No.: US 2012/0075362 A1
(43) Pub. Date: Mar. 29, 2012

(54) Image Display Device And Control Method Therefor

(75) Inventors: Hideki Ichioka, Osaka (JP); Kohji Fujiwara, Osaka (JP)

(73) Assignee: SHARP KABUSHIKI KAISHA, Osaka-shi, Osaka (JP)

(21) Appl. No.: 13/377,050

(22) PCT Filed: Feb. 2, 2010
(86) PCT No.: PCT/JP2010/051426

§ 371 Date: Dec. 8, 2011

(30) Foreign Application Priority Data
Jun. 17, 2009 (JP) 2009-143892

(51) Int. Cl. G09G 5/10; G09G 3/36

(52) U.S. Cl. 345/690; 345/102

(57) ABSTRACT

In an LCD data calculation section, a base data calculation section calculates LCD data before temperature compensation based on an input image and display luminance of each area of a backlight, a scene change detection section detects a scene change point at which the amount of change of the input image increases, based on the input image, and an LUT selection and application section acquires an appropriate table corresponding to the temperature of a liquid crystal panel from a temperature compensation LUT, and applies the table at the scene change point, thereby outputting LCD data subjected to temperature compensation. Thus, temperature compensation can be performed without adversely affecting display luminances of the backlight, making it possible to correctly provide tone display without uneven luminances even in the case of area-active drive.

### TECHNICAL FIELD

The present invention relates to image display devices and control methods therefor, particularly to an image display device with the function of controlling the luminance of a backlight (backlight dimming function) and a control method therefor.

### BACKGROUND ART

Image display devices, such as liquid crystal display devices, each of which includes a backlight, can control the luminance of the backlight based on an input image, thereby suppressing power consumption by the backlight and improving display image quality. In particular, a screen is divided into a plurality of areas, and luminances of backlight sources corresponding to the areas are controlled based on portions of the input image within the areas, making it possible to achieve lower power consumption and higher image quality. Hereinafter, such a method for driving a display panel while controlling luminances of backlight sources based on input image portions within areas will be referred to below as “area-active drive”. Note that the area-active drive is also called “local dimming drive”.

Area-active drive image display devices often use LEDs (light emitting diodes) of three colors, i.e., R, G and B, and LEDs of white as backlight sources. Luminances (luminances upon light emission) of LEDs corresponding to areas are obtained based on, for example, maximum or mean pixel luminances within the areas, and provided to a backlight driver circuit as LED data. In addition, display data (in the case of liquid crystal display devices, data for controlling the light transmittance of the liquid crystal) is generated based on the LED data and an input image, and the display data is provided to a display panel driver circuit. In the case of liquid crystal display devices, the luminance of each pixel on the screen is the product of the luminance of light from the backlight and the light transmittance based on the display data.

In the liquid crystal display devices as mentioned above, the display data and the LED data are appropriately obtained based on an input image, the light transmittance of the liquid crystal is controlled based on the display data, and luminances of LEDs corresponding to areas are controlled based on the LED data, so that the input image can be displayed on the liquid crystal panel. In addition, when luminances of pixels within an area are low, luminances of LEDs corresponding to that area are kept low, thereby reducing power consumption by the backlight.

Note that the following conventional technology documents are known in the art relevant to the present invention. Japanese Laid-Open Patent Publication No. 2005-338857 discloses an invention of a liquid crystal display device with a backlight unit including LEDs for emitting light individually for each of a plurality of divided areas. Also, Japanese Laid-Open Patent Publication No. 2001-142409 discloses an invention of a liquid crystal display device in which at least one LED is arranged for each of a plurality of divided areas, and any area that needs no illumination is left unilluminated.

### CITATION LIST

### Patent Document

[Patent Document 1] Japanese Laid-Open Patent Publication No. 2005-338857

[Patent Document 2] Japanese Laid-Open Patent Publication No. 2001-142409

### SUMMARY OF THE INVENTION

### Problems to be Solved by the Invention

However, in the conventional art as described above, the transmittance of the liquid crystal changes due to temperature variations, and therefore even in the case where input image data is corrected in accordance with ideal gamma characteristics, the ideal gamma characteristics are not always achieved in a display image.

In view of this, in the conventional art, it is conceivable to correct an input image for temperature compensation. However, in the conventional art, since not only the display data but also the LED data is obtained based on an input image as described earlier, if the above correction is performed, temperature compensation can be achieved for the display data, but the LED data is changed to abnormal values, resulting in an abnormal display image (e.g., a yellowish display state).

Furthermore, in the case of the area-active drive as in the conventional art, even if display is provided in the same tone, light-emission luminances of LEDs vary from one area to another, and in such a case, the transmittance of the liquid crystal also differs area by area. As a result, the amount of change in the transmittance of the liquid crystal due to temperature variations might differ among the areas, and in such a case, the differences conspicuously appear in a display image as uneven luminances among the areas.

Therefore, an objective of the present invention is to provide an area-active drive image display device and a control method therefor, in which temperature compensation can be performed while correctly providing tone display without uneven luminances.

### Solution to the Problems

A first aspect of the present invention is directed to an image display device with a function of controlling backlight luminances, comprising:

a display panel including a plurality of display elements;

temperature detection means for detecting a temperature of the display panel;

a backlight including a plurality of light sources;

a light-emission luminance calculation section for dividing an input image into a plurality of areas and obtaining light-emission luminance data based on the input image, the light-emission luminance data indicating luminances of light sources upon light emission for each corresponding area;

a display data calculation section for obtaining display data to control light transmittances of the display elements, based on the input image and the light-emission luminance data obtained by the light-emission luminance calculation section;

temperature compensation means for calculating correction values to compensate for changes in the light transmittances due to temperature variations, based on the temperature detected by the temperature detection means, and correcting the display data based on the calculated correction values;

a panel driver circuit for outputting to the display panel a signal for controlling the light transmittances of the display elements based on the display data corrected by the temperature compensation means; and

a backlight driver circuit for outputting to the backlight a signal for controlling the luminances of the light sources based on the light-emission luminance data.

In a second aspect of the present invention, based on the first aspect of the invention, the temperature compensation means includes timing detection means for detecting a time point at which any luminance change that occurs due to correction of the display data is invisible or less visible, and the correction values are calculated at the time point detected by the timing detection means.

In a third aspect of the present invention, based on the second aspect of the invention, the timing detection means detects a scene change point at which the amount of change of the input image is greater than a predetermined threshold.

In a fourth aspect of the present invention, based on the third aspect of the invention, the timing detection means detects as the scene change point at least one of a switch point between video channels on which to provide the input image and a switch point between video display modes representing display formats on the display panel.

In a fifth aspect of the present invention, based on the first aspect of the invention, the temperature detection means divides a display area of the display panel into a plurality of divided display areas and detects temperatures for the respective divided display areas, and the temperature compensation means calculates correction values to compensate for the changes in the light transmittances due to temperature variations in the divided display areas, based on the temperatures detected for the respective divided display areas by the temperature detection means, and corrects the display data based on the correction values calculated for the respective divided display areas.

In a sixth aspect of the present invention, based on the first aspect of the invention, further comprised are:

backlight temperature detection means for detecting a temperature of the backlight; and

backlight temperature compensation means for calculating correction values to compensate for changes in luminances of the light sources due to temperature variations, based on the temperature detected by the backlight temperature detection means, and correcting the light-emission luminance data based on the calculated correction values, wherein,

the backlight driver circuit outputs signals for controlling the luminances of the light sources to the backlight based on the light-emission luminance data corrected by the backlight temperature compensation means.

A seventh aspect of the present invention is directed to a method for controlling an image display device which has a function of controlling backlight luminances and is provided with a display panel including a plurality of display elements and a backlight including a plurality of light sources, the method comprising:

a temperature detection step of detecting a temperature of the display panel;

a light-emission luminance calculation step of dividing an input image into a plurality of areas and obtaining light-emission luminance data based on the input image, the light-emission luminance data indicating luminances of light sources upon light emission for each corresponding area;

a display data calculation step of obtaining display data to control light transmittances of the display elements, based on the input image and the light-emission luminance data obtained in the light-emission luminance calculation step;

a temperature compensation step of calculating correction values to compensate for changes in the light transmittances due to temperature variations, based on the temperature detected in the temperature detection step, and correcting the display data based on the calculated correction values;

a panel driving step of controlling the display panel in terms of the light transmittances of the display elements based on the display data corrected in the temperature compensation step; and

a backlight driving step of controlling the backlight in terms of the luminances of the light sources based on the light-emission luminance data.

### Effect of the Invention

According to the first aspect of the present invention, since the temperature compensation means calculates correction values to compensate for changes in light transmittances of display elements due to temperature variations, based on a detected temperature, and display data is corrected based on the calculated correction values, light source luminances of the backlight are not adversely affected by the display elements being subjected to temperature compensation, making it possible to correctly provide tone display without uneven luminances where area-active drive is performed.

According to the second aspect of the present invention, since (new) correction values are calculated at a time point detected by the timing detection means where any luminance change that occurs due to correction is invisible or less visible, users can view images without feeling the images to be unnatural even when any luminance change occurs due to correction values being changed.

According to the third aspect of the present invention, since the timing detection means detects a scene change point at which the amount of change of the input image is greater than a predetermined threshold, any luminance change that occurs due to correction is invisible or less visible, so that users can view images without feeling the images to be unnatural.

According to the fourth aspect of the present invention, since the timing detection means detects as the scene change point either a switch point between video channels or a switch point between video display modes, or both, it becomes possible to readily detect (typical) scene change points.

According to the fifth aspect of the present invention, the temperatures of the respective divided display areas are detected, correction values are calculated based on the detected temperatures to compensate for the changes in the light transmittances due to temperature variations in the divided display areas, thereby correcting the display data, and therefore, for example, even in the case where the display area is large, hence there are differences in temperature between the divided areas, it is possible to perform accurate temperature compensation based on temperatures corresponding to the positions of display elements.

According to the sixth aspect of the present invention, since the backlight temperature compensation means calculates correction values to compensate for changes in luminances of the light sources due to temperature variations, based on detected temperatures, and corrects the light-emission luminance data based on the calculated correction values, it becomes possible to further correctly provide tone display without being adversely affected by temperature variations by additionally subjecting the light sources to temperature compensation.

According to the seventh aspect of the present invention, the image display device control method can achieve the same effect as that achieved by the first aspect of the present invention.

### BRIEF DESCRIPTION OF THE DRAWINGS

FIG. 1 is a block diagram illustrating the configuration of a liquid crystal display device according to an embodiment of the present invention.

FIG. 2 is a diagram illustrating details of a backlight shown in FIG. 1.

FIG. 3 is a block diagram illustrating a detailed configuration of an area-active drive processing section in the embodiment.

FIG. 4 is a diagram for explaining a luminance spread filter.

FIG. 5 is a flowchart showing a process by the area-active drive processing section in the embodiment.

FIG. 6 is a diagram showing the course of action up to obtaining liquid crystal data and LED data in the embodiment.

FIG. 7 is a block diagram illustrating a detailed configuration of a LCD data calculation section in the embodiment.

FIG. 8 is a graph showing the correspondence between tones and luminances of a liquid crystal panel in the embodiment for a plurality of temperatures.

### MODE FOR CARRYING OUT THE INVENTION

Hereinafter, an embodiment of the present invention will be described with reference to the accompanying drawings.

<1.1 Overall Configuration and Overview of Operation>

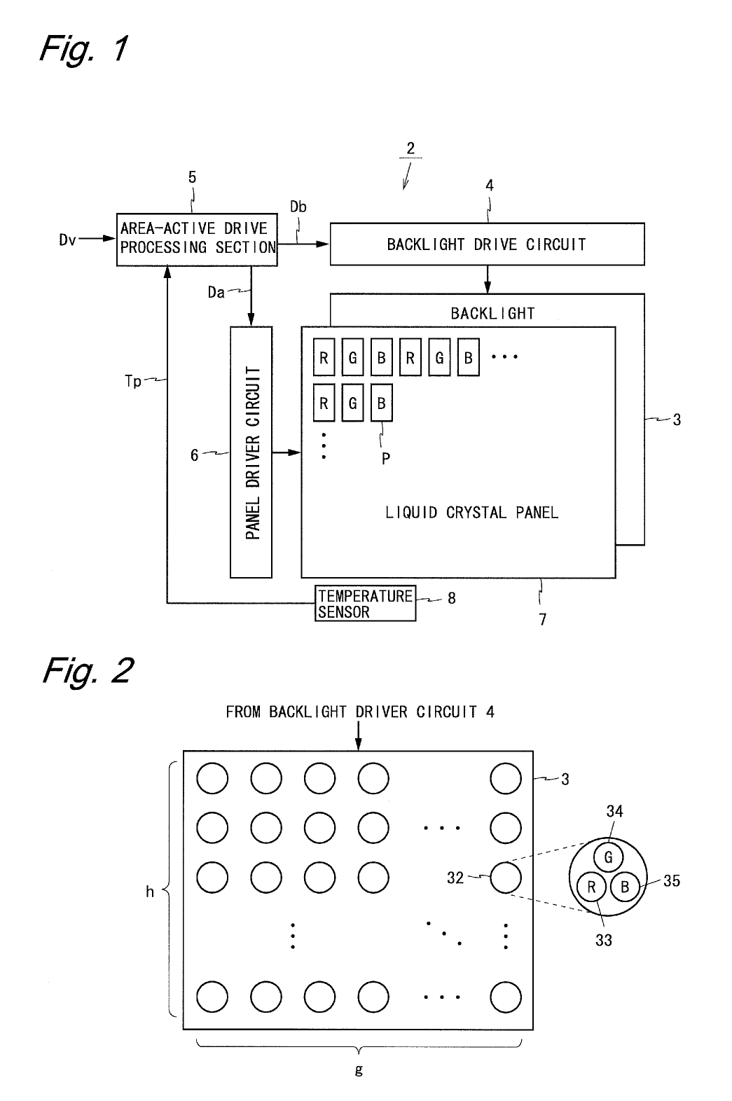

FIG. 1 is a block diagram illustrating the configuration of a liquid crystal display device 2 according to an embodiment of the present invention. The liquid crystal display device 2 shown in FIG. 1 includes a backlight 3, a backlight driver circuit 4, a panel driver circuit 6, a liquid crystal panel 7, a temperature sensor 8, and an area-active drive processing section 5. The liquid crystal display device 2 performs area-active drive in which the liquid crystal panel 7 is driven with luminances of backlight sources being controlled based on input image portions within a plurality of areas defined by dividing the screen. In the following, m and n are integers of 2 or more, i and j are integers of 1 or more, but at least one of i and j is an integer of 2 or more.

The liquid crystal display device 2 receives an input image Dv including an R image, a G image, and a B image. Each of the R, G, and B images includes luminances for (m×n) pixels. Based on the input image Dv, the area-active drive processing section 5 obtains display data (hereinafter, referred to as “liquid crystal data Da”) for use in driving the liquid crystal panel 7 and backlight control data (hereinafter, referred to as “LED data Db”) for use in driving the backlight 3 (details will be described later).

Here, the liquid crystal display device 2 is a television device, and specifically, the input image Dv is generated by an unillustrated television set (television controller) based on an externally provided color television signal (video signal). In this case, the television set generates the input image Dv by performing gamma correction individually on each of the R, G, and B images so that a gamma correction curve suitable for the liquid crystal panel 7 can be obtained for the video signal. However, for convenience of explanation, it is assumed here to use γ=2.2, which is considered to be an ideal gamma value for color television signals in Japan. The liquid crystal panel 7 includes (m×n×3) display elements P. The display elements P are arranged two-dimensionally as a whole, with each row including 3m of them in its direction (in FIG. 1, horizontally) and each column including n of them in its direction (in FIG. 1, vertically). The display elements P include R, G, and B display elements respectively transmitting red, green, and blue light therethrough. Each set of three display elements, i.e., R, G, and B, arranged in the row direction forms a single pixel. The temperature sensor 8 measures the temperature of the liquid crystal panel 7, and outputs a temperature measurement signal Tp.

The panel driver circuit 6 is a circuit for driving the liquid crystal panel 7. Based on liquid crystal data Da outputted by the area-active drive processing section 5, the panel driver circuit 6 outputs signals (voltage signals) to the liquid crystal panel 7 to control light transmittances of the display elements P. The voltages outputted by the panel driver circuit 6 are written to pixel electrodes (not shown) in the display elements P, and the light transmittances of the display elements P change in accordance with the voltages written to the pixel electrodes.

The backlight 3 is provided at the back side of the liquid crystal panel 7 to irradiate backlight to the back of the liquid crystal panel 7. FIG. 2 is a diagram illustrating details of the backlight 3. The backlight 3 includes (i×j) LED units 32, as shown in FIG. 2. The LED units 32 are arranged two-dimensionally as a whole, with each row including i of them in its direction and each column including j of them in its direction. Each of the LED units 32 includes one red LED 33, one green LED 34, and one LED blue 35. The three LEDs 33 to 35 included in each LED unit 32 emit light to be incident on a part of the back of the liquid crystal panel 7.

The backlight driver circuit 4 is a circuit for driving the backlight 3. Based on LED data Db outputted by the area-active drive processing section 5, the backlight driver circuit 4 outputs signals (voltage signals or current signals) to the backlight 3 to control luminances of the LEDs 33 to 35. The luminances of the LEDs 33 to 35 are controlled independently of luminances of LEDs inside and outside their units.

The screen of the liquid crystal display device 2 is divided into (i×j) areas, each corresponding to one LED unit 32. Note that each area may correspond to two or more LED units 32. For each of the (i×j) areas, the area-active drive processing section 5 obtains the luminance of the red LED 33 corresponding to that area based on an R image within the area. Similarly, the luminance of the green LED 34 is determined based on a G image within the area, and the luminance of the blue LED 35 is determined based on a B image within the area. The area-active drive processing section 5 obtains luminances for all LEDs 33 to 35 included in the backlight 3, and outputs LED data Db representing the obtained LED luminances to the backlight driver circuit 4.

Furthermore, based on the LED data Db, the area-active drive processing section 5 obtains backlight luminances for all display elements P included in the liquid crystal panel 7. In addition, based on an input image Dv and the backlight luminances, the area-active drive processing section 5 obtains light transmittances of all of the display elements P included in the liquid crystal panel 7, and outputs liquid crystal data Da representing the obtained light transmittances to the panel driver circuit 6. Note that the method by which the area-active drive processing section 5 obtains the backlight luminances will be described in detail later.

In the liquid crystal display device 2, the luminance of each R display element is the product of the luminance of red light emitted by the backlight 3 and the light transmittance of that R display element. Light emitted by one red LED 33 is incident on a plurality of areas around one corresponding area. Accordingly, the luminance of each R display element is the product of the total luminance of light emitted by a plurality of red LEDs 33 and the light transmittance of that R display element. Similarly, the luminance of each G display element is the product of the total luminance of light emitted by a plurality of green LEDs 34 and the light transmittance of that G display element, and the luminance of each B display element is the product of the total luminance of light emitted by a plurality of blue LEDs 35 and the light transmittance of that B display element.

In the liquid crystal display device 2 thus configured, the liquid crystal data Da and the LED data Db are appropriately obtained based on the input image Dv, the light transmittances of the display elements P are controlled based on the liquid crystal data Da, the luminances of the LEDs 33 to 35 are controlled based on the LED data Db, so that the input image Dv can be displayed on the liquid crystal panel 7. In addition, when luminances of pixels within an area are low, the luminances of LEDs 33 to 35 corresponding to that area are kept low, thereby reducing power consumption by the backlight 3. Moreover, when luminances of pixels within an area are low, luminances of display elements P corresponding to that area are switched among a smaller number of levels, making it possible to enhance image resolution and thereby to improve display image quality.

<1.2 Configuration of the Area-Active Drive Processing Section>

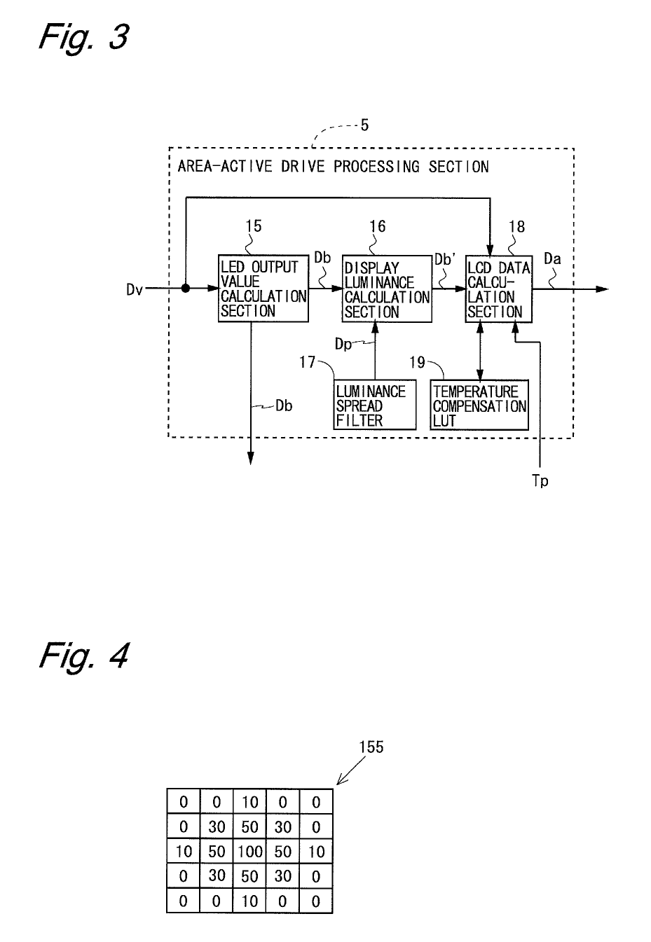

FIG. 3 is a block diagram illustrating a detailed configuration of the area-active drive processing section 5 in the present embodiment. The area-active drive processing section 5 includes an LED output value calculation section 15, a display luminance calculation section 16, and an LCD data calculation section 18 as components for performing a predetermined process, and also includes a luminance spread filter 17 and a temperature compensation look-up table (hereinafter, abbreviated as a “temperature compensation LUT”) 19 as components for storing predetermined data. Here, in the present embodiment, a light-emission luminance calculation section is realized by the LED output value calculation section 15, and a display data calculation section is realized by the LCD data calculation section 18. Note that the LED output value calculation section 15 also includes a component for storing predetermined data.

The LED output value calculation section 15 divides the input image Dv into a plurality of areas, and obtains LED data (light-emission luminance data) Db indicating luminances of LEDs upon light emission for each corresponding area. Note that a value for the luminance of an LED upon light emission will be referred to below as an “LED output value”. The luminance spread filter 17 has stored therein, for example, PSF data, which is data representing the spread of light as numerical values, as shown in FIG. 4, to calculate display luminance for each area.

The display luminance calculation section 16 calculates display luminance Db′ for each area based on the LED data Db obtained by the LED output value calculation section 15 and the PSF data Dp stored in the luminance spread filter 17.

Based on the input image Dv and also on the display luminance Db′ obtained for each area by the display luminance calculation section 16, the LCD data calculation section 18 obtains liquid crystal data, and performs temperature compensation on the obtained liquid crystal data with reference to an appropriate one of a plurality of tables included in the temperature compensation LUT 19 that corresponds to a temperature measurement signal Tp from the temperature sensor 8, thereby obtaining liquid crystal data Da representing light transmittances of all display elements P included in the liquid crystal panel 7. The temperature compensation will be described later.

<1.3 Processing Procedure by the Area-Active Drive Processing Section>

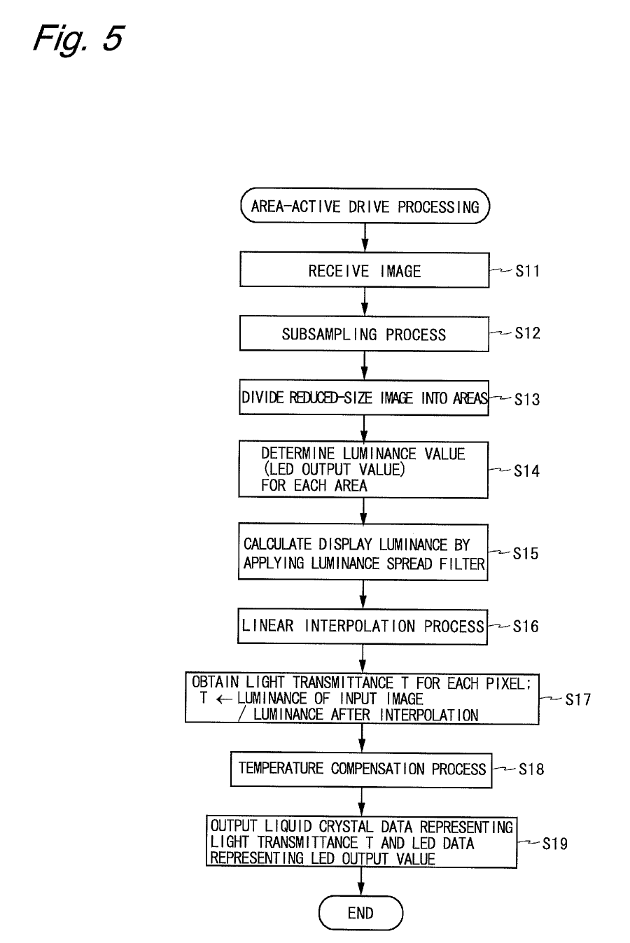

FIG. 5 is a flowchart showing a process by the area-active drive processing section 5. The area-active drive processing section 5 receives an image for a color component (hereinafter, referred to as color component C) included in the input image Dv (step S11). The received image for color component C includes luminances for (m×n) pixels.

Next, the area-active drive processing section 5 performs a subsampling process (averaging process) on the received image for color component C, and obtains a reduced-size image including luminances for (sᵢ×sⱼ) (where s is an integer of 2 or more) pixels (step S12). In step S12, the received image for color component C is reduced to sᵢ/m in the horizontal direction and sⱼ/n in the vertical direction. Then, the area-active drive processing section 5 divides the reduced-size image into (i×j) areas (step S13). Each area includes luminances for (s×s) pixels.

Next, the area-active drive processing section 5 obtains LED output values (luminance values of LEDs upon light emission) for each of the (i×j) areas (step S14). Methods conventionally known for determining the LED output values include, for example, a method that makes a determination based on a maximum pixel luminance Ma within each area, a method that makes a determination based on a mean pixel luminance Me within each area, and a method that makes a determination based on a value obtained by calculating a weighted mean of the maximum pixel luminance Ma and the mean pixel luminance Me within each area, but in the present embodiment, the LED output values are not simply determined in disregard of the relationship with other areas but in consideration of luminances of LED units in surrounding areas. Details will be described later. Note that the processes of steps S11 to S14 are performed by the LED output value calculation section 15 within the area-active drive processing section 5.

Next, the area-active drive processing section 5 applies a luminance spread filter (point spread filter) 17 to the (i×j) LED output values obtained in step S14, thereby obtaining first backlight luminance data including (tᵢ×tⱼ) (where t is an integer of 2 or more) display luminances (step S15). In step S15, the (i×j) LED output values are increased to t-fold both in the horizontal and the vertical direction, thereby obtaining (tᵢ×tⱼ) display luminances. Note that the process of step S15 is performed by the display luminance calculation section 16 within the area-active drive processing section 5.

Next, the area-active drive processing section 5 performs a linear interpolation process on the first backlight luminance data, thereby obtaining second backlight luminance data including (m×n) luminances (step S16). In step S16, the first backlight luminance data is increased to (m/tᵢ)-fold in the horizontal direction and (n/tⱼ)-fold in the vertical direction. The second backlight luminance data represents backlight luminances for color component C incident on (m×n) display elements P for color component C where (i×j) LEDs for color component C emit light with the luminances obtained in step S14.

Next, the area-active drive processing section 5 divides the luminances of the (m×n) pixels included in the input image for color component C respectively by the (m×n) luminances included in the second backlight luminance data, thereby obtaining light transmittances T for the (m×n) display elements P for color component C (step S17).

Subsequently, the area-active drive processing section 5 performs a temperature compensation process by referring to the temperature compensation LUT 19 and subjecting liquid crystal data, which represents the (m×n) light transmittances obtained in step S17, to temperature compensation in accordance with temperatures detected by the temperature sensor 8, thereby obtaining liquid crystal data Da representing the final light transmittances (step S18). Note that the processes of steps S16 to S18 are performed by the LCD data calculation section 18 within the area-active drive processing section 5.

Finally, for color component C, the area-active drive processing section 5 outputs the liquid crystal data Da obtained in step S18, which represents the (m×n) light transmittances, and LED data Db which represents the (i×j) LED output values obtained in step S14 (step S19). At this time, the liquid crystal data Da and the LED data Db are converted to values within appropriate ranges in conformity with the specifications of the panel driver circuit 6 and the backlight driver circuit 4.

The area-active drive processing section 5 performs the process shown in FIG. 5 on an R image, a G image, and a B image, thereby obtaining liquid crystal data Da representing (m×n×3) transmittances and LED data Db representing (i×j×3) LED output values, based on an input image Dv including luminances for (m×n×3) pixels.

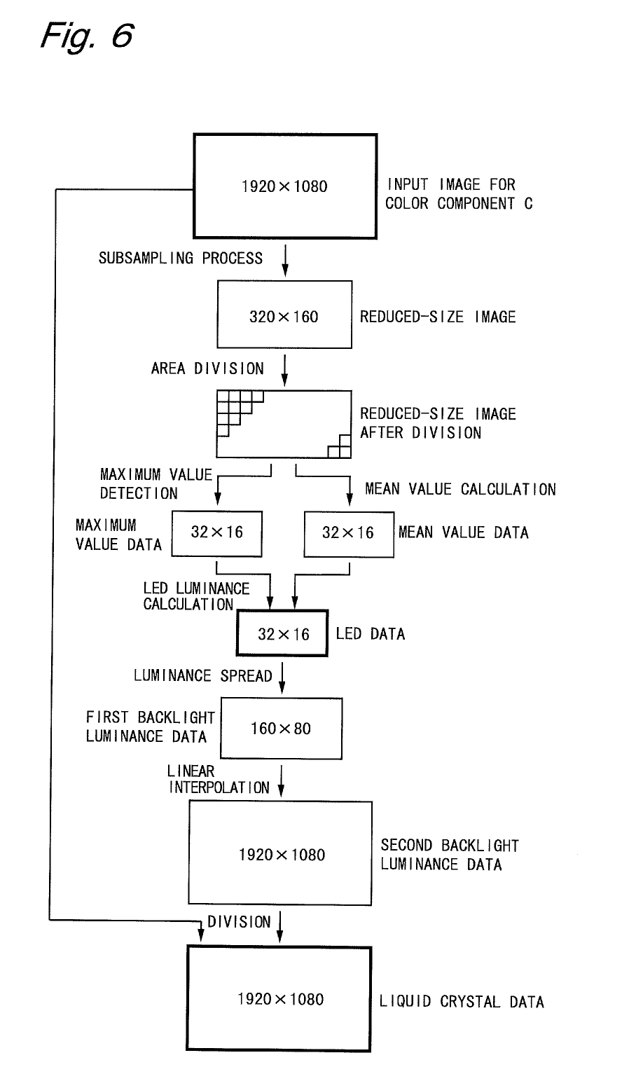

FIG. 6 is a diagram showing the course of action up to obtaining liquid crystal data and LED data where m=1920, n=1080, i=32, j=16, s=10, and t=5. As shown in FIG. 6, a subsampling process is performed on an input image for the color component C, which includes luminances of (1920×1080) pixels, thereby obtaining a reduced-size image including luminances of (320×160) pixels. The reduced-size image is divided into (32×16) areas (the size of each area is (10×10) pixels). For each area, the maximum value Ma and the mean value Me for the pixel luminances are calculated, thereby obtaining maximum value data including (32×16) maximum values and mean value data including (32×16) mean values. Then, based on the maximum value data or the mean value data, alternatively, based on weighted averaging of the maximum value data and the mean value data, LED data for the color component C, which represents (32×16) LED luminances (LED output values), is obtained.

The luminance spread filter 17 is applied to the LED data for the color component C, thereby obtaining first backlight luminance data including (160×80) display luminances. Then, a linear interpolation process is performed on the first backlight luminance data, thereby obtaining second backlight luminance data including (1920×1080) display luminances. Finally, the pixel luminances included in the input image are divided by the display luminances included in the second backlight luminance data, thereby obtaining liquid crystal data for the color component C, which includes (1920×1080) light transmittances.

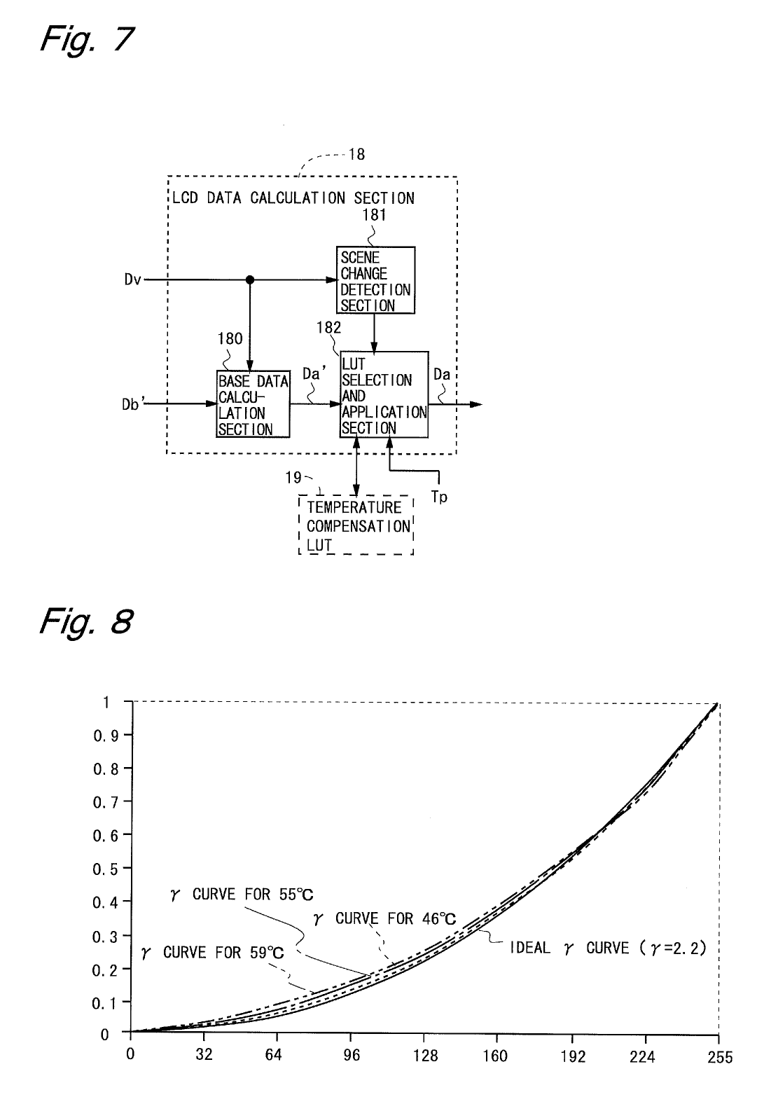

Note that in FIG. 5, for ease of explanation, the area-active drive processing section 5 sequentially performs the process on images for color components, but the process may be performed on the images for color components in a time-division manner. Furthermore, in FIG. 5, the area-active drive processing section 5 performs a subsampling process on an input image for noise removal and performs area-active drive based on a reduced-size image, but the area active drive maybe performed on the original input image. Next, the operation in step S18 for temperature compensation by the LCD data calculation section 18 will be described with reference to FIG. 7.

<1.4 Detailed Configuration of the LCD Data Calculation Section and Temperature Compensation Operation>

FIG. 7 is a block diagram illustrating a detailed configuration of the LCD data calculation section 18. As shown in FIG. 7, the LCD data calculation section 18 includes a base data calculation section 180 for calculating LCD data Da′ before temperature compensation as described earlier, a scene change detection section 181 for detecting a scene change in images, and an LUT selection and application section 182 for acquiring and applying an appropriate table from the temperature compensation LUT 19 that corresponds to the temperature of the liquid crystal panel.

The base data calculation section 180 obtains LCD data Da′ before temperature compensation, based on an input image Dv and also on display luminances Db′ obtained for each area by the display luminance calculation section 16. The specific method for obtaining the data is as described above.

Based on the input image Dv, the scene change detection section 181 determines for each frame whether a scene change has occurred, and if it is determined to have occurred, the scene change detection section 181 provides a scene change detection signal to the LUT selection and application section 182. Typically, the determination that a scene change has occurred is made when there is a switch between video scenes included in dynamic images, including any case where the image content changes significantly between one frame and the next frame, e.g., in the case where the image content of dynamic images changes significantly. Specifically, the scene change is determined to have occurred, for example, when a mean luminance, shade, or pattern of an entire input image changes between one frame and the next frame more than a predetermined threshold (hereinafter, such a case will be referred to by “when the amount of change between images is greater than a predetermined threshold”).

Note that the occurrence of such a scene change can be similarly determined based on LCD data Da′. Moreover, in addition to or in place of using the determination method as described above, any scene change may be determined to have occurred when the scene change detection section 181 receives a signal indicating the result that the television set or such like detected a switch between video channels on which to supply input images Dv or video modes which represent formats in which to present display images on the television device. For example, when video channels are switched, a scene change occurs in which the pattern of an image changes significantly, and when the video mode is switched from standard to movie, a scene change occurs in which the luminance or shade of an image changes significantly. Accordingly, by detecting switches as mentioned, scene changes can be readily detected. Furthermore, it is possible to employ other well-known scene change detection techniques.

Upon each reception of a scene change detection signal from the scene change detection section 181, or upon reception of a scene change detection signal after a lapse of a predetermined period of time or after a temperature change greater than or equal to a predetermined magnitude, the LUT selection and application section 182 acquires a temperature measurement signal Tp from the temperature sensor 8, and acquires a table corresponding to the temperature of the liquid crystal panel 7 that is indicated by the temperature measurement signal Tp from among a plurality of tables included in the temperature compensation LUT 19. Specifically, the temperature compensation LUT 19 includes a plurality of tables corresponding to a plurality of prescribed (or normally possible) temperature ranges of the liquid crystal panel. Typically, these tables are generated based on measurement results for changes of an ideal gamma curve with respect to the temperature.

FIG. 8 is a graph showing the correspondence between tones and luminances of the liquid crystal panel for a plurality of temperatures. In FIG. 8, the horizontal axis represents tone values at up to 255 that correspond to liquid crystal data, and the vertical axis represents luminance values standardized with the maximum luminance set at 1. Furthermore, the solid line represents an ideal gamma curve (γ=2.2), the dotted line represents a gamma curve where the temperature of the liquid crystal panel is 46° C., the dashed dotted line represents a gamma curve where the temperature of the liquid crystal panel is 55° C., and the dashed double-dotted line represents a gamma curve where the temperature of the liquid crystal panel is 59° C.

As can be seen from FIG. 8, the higher the temperature of the liquid crystal panel becomes, the more the gamma curve deviates from the ideal gamma curve, and for each temperature, the luminance of the gamma curve is generally greater than that of the ideal gamma curve from tone 0 to approximately tone 210 and generally less than that of the ideal gamma curve from tone 210 to tone 255. In this manner, the gamma curves for the temperatures do not deviate uniformly (by the same tone value) from the ideal gamma curve, and therefore in the case of area-active drive, when the light-emission luminances of the LEDs vary from one area to another, such variations appear as uneven luminances among areas in display images. Such uneven luminances may be referred to by the term “halo phenomenon”.

In the case where gamma curves for various temperatures are already known (from experimentation, simulation, etc.) as in the case of FIG. 8, luminances for the temperatures at any given tone value are known regarding their respective deviations from an ideal gamma curve, and therefore temperature compensation can be readily performed by multiplying an LCD data value, which indicates a tone value, by a predetermined coefficient or by adding/subtracting a predetermined offset value to/from the LCD data, value.

Therefore, normally possible temperatures of the liquid crystal panel 7 are classified into a plurality of ranges, the coefficient or offset value for use in correction for each tone (hereinafter, such a value will be referred to as a “correction value”) is calculated for each of the classified temperature ranges based on the results, and stored (to a predetermined storage device such as EPROM) as temperature compensation LUT 19 in the form of a corresponding table. Note that the table does not necessarily include correction values for all tones, and may only include a plurality of representative values and interpolate values between the representative values (using a predetermined line or curve). Furthermore, correction values may be calculated using a predetermined calculation formula in place of the table. The calculation formula can be provided in various possible forms, e.g., it may be simply structured to perform correction by multiplying each tone by a predetermined temperature coefficient. This configuration results in less accurate temperature compensation compared to the configuration in which tables are used, but it eliminates the need to store large tables, making it possible to save the memory capacity of the storage device.

Here, as described earlier, the LUT selection and application section 182 performs the operation to switch tables upon reception of the scene change detection signal. If a changed correction value is applied, the luminances of a display image change, and therefore the operation is performed at a scene change where the amount of change between display images is greater than a predetermined threshold, thereby rendering any display abnormality invisible to the user. Accordingly, the switching operation may or may not be performed both at the time of a scene change and at a predetermined time point where any display abnormality is invisible to the user, e.g., all luminances of a display image are zero or extremely low (dark). That is, it is necessary for the scene change detection section 181 to simply function as timing detection means for detecting a time point where any luminance change that occurs in an image at the time of switching tables is invisible or less visible to users. As a result, users can view images without feeling the images to be unnatural even when any luminance change occurs due to correction values being changed.

The LUT selection and application section 182 refers to the table thus switched without modifying it until the next switching point, and corrects the LCD data Da′ received from the base data calculation section 180, which is not subjected to temperature compensation, by applying a corresponding correction value thereto before outputting LCD data Da subjected to temperature compensation.

<2. Effect>

As described above, the LCD data calculation section 18 of the present embodiment refers to the temperature compensation LUT 19 to acquire a correction value corresponding to the temperature of the liquid crystal panel 7 obtained from the temperature sensor 8, and outputs the LCD data Da subjected to temperature compensation based on the correction value, and therefore even if transmittances of the liquid crystal change due to temperature variations, input image data is corrected in accordance with ideal gamma characteristics. Thus, the present liquid crystal display device can provide correct (ideal) tone display without uneven luminances (such as halo phenomenon) even if temperature variations occur during area-active drive.

<3. Variant>

In the above embodiment, the liquid crystal panel 7 is provided with only one temperature sensor 8, but particularly, in the case of recent large-sized liquid crystal panels, the difference in temperature is significant between the center of the screen and peripheral areas, and therefore, a plurality of temperature sensors 8 may be attached as necessary so that their mean temperature value can be used.

Furthermore, in the case where a plurality of temperature sensors 8 are attached, temperature compensation may be performed for each attachment position. Specifically, from among the tables included in the temperature compensation LUT 19, the LUT selection and application section 182 acquires tables corresponding to temperatures acquired from the temperature sensors 8 for corresponding areas (hereinafter, referred to as “divided display areas”) of the liquid crystal panel 7. The LUT selection and application section 182 corrects LCD data Da′ received from the base data calculation section 180, which is not subjected to temperature compensation, by applying a corresponding correction value to each of the divided display areas, i.e., each piece of pixel data included in the divided display areas, before outputting LCD data Da subjected to temperature compensation. In this manner, temperature compensation can be performed minutely for each of the predetermined divided display areas, and therefore, even if the temperature differs in various portions of a large-sized liquid crystal panel 7, accurate temperature compensation can be performed. Thus, the present liquid crystal display device can more accurately provide correct tone display without uneven luminances even if temperature variations occur during area-active drive.

Note that the divided display areas are appropriately determined in accordance with temperature variation characteristics of the liquid crystal panel 7, but the number of divided display areas does not have to coincide with the number of temperature sensors 8. For example, in the case where there is any divided display area in which no temperature sensor 8 is attached, the temperature of that divided display area may be estimated based on a temperature/temperatures measured by one or more adjacent temperature sensors 8. In this manner, temperature detection of the divided display areas may be performed by estimation based on measurement results by the temperature sensors 8.

Furthermore, in the above embodiment, the temperature sensors 8 are attached to the liquid crystal panel 7, but they may be attached at positions away from the liquid crystal panel 7 but close enough to be able to gauge ambient temperatures. In addition, it may be possible to divert temperature sensors intended to measure temperatures of other boards of the liquid crystal display device or the temperature of a (main) board of the television set. Further still, instead of using the temperature sensors 8, it may be possible to apply well-known features for estimating (detecting) the temperature of the liquid crystal panel 7 based on, for example, the amount of current flowing in the liquid crystal panel 7 per unit time.

In the above embodiment, temperature compensation is performed only on the liquid crystal panel 7, but temperature compensation may be performed on the backlight 3 as well. Specifically, since LEDs, which are light sources in the backlight 3, have different temperature characteristics (characteristics concerning LED light-emission luminance variations with respect to temperature variations) from the liquid crystal panel 7, temperature sensors may be attached to the housing of one or more LED units 32 or the backlight 3 or in their vicinities, and the LED output value calculation section 15 of the area-active drive processing section 5 may include a backlight temperature compensation LUT. In such a configuration, temperature compensation is preferably performed by applying a correction value after selecting an appropriate table from the backlight temperature compensation LUT, as in the foregoing in conjunction with the LUT selection and application section 182. Note that backlight temperature compensation may be performed as in the case of temperature compensation of the liquid crystal panel 7, based on the temperature of the backlight which is estimated based on temperatures obtained by temperature sensors attached at appropriate positions while taking account of, for example, distances from the positions, compositions of sheets and such like, and other temperatures including outside temperature, board temperature. Accordingly, the temperature sensors may be identical to the temperature sensors 8.

Furthermore, the LCD data calculation section 18 may perform temperature compensation on the liquid crystal panel 7 and further temperature compensation on the backlight 3. Specifically, while in the above embodiment, the LCD data calculation section 18 obtains liquid crystal data Da by performing temperature compensation on obtained liquid crystal data with reference to appropriate tables included in the temperature compensation LUT 19 that correspond to temperature measurement signals Tp from the temperature sensors 8, the obtained liquid crystal data Da may be subjected to additional backlight temperature compensation with reference to appropriate tables included in the backlight temperature compensation LUT that correspond to temperature measurement signals from temperature sensors attached, for example, to the housing of the backlight 3 and in its vicinity, as described above. Moreover, the backlight LUT and the temperature compensation LUT 19 may be combined as one LUT to be referenced to obtain one correction value corresponding to the aforementioned two types of temperature.

While in the above embodiment, the LUT selection and application section 182 includes the scene change detection section 181 as timing detection means, a table switching operation may be performed in a continuous manner, at predetermined time intervals, or upon occurrence of a temperature variation of a predetermined magnitude, without performing timing detection. In such a case, any change of luminances in images that occur when the tables are switched might be visible to the user, but it is possible to provide correct tone display without uneven luminances even if temperature variations occur during area-active drive.

### INDUSTRIAL APPLICABILITY

The present invention can be applied to, for example, image display devices each including a backlight for illuminating a liquid crystal panel from the back, and is suitable for image display devices with the function (backlight dimming function) of controlling backlight luminances.

### DESCRIPTION OF THE REFERENCE CHARACTERS

2 liquid crystal display device

3 backlight

4 backlight driver circuit

5 area-active drive processing section

6 panel driver circuit

7 liquid crystal panel

8 temperature sensor

15 LED output value calculation section

16 display luminance calculation section

17 luminance spread filter

18 LCD data calculation section

19 temperature compensation LUT

180 base data calculation section

181 scene change detection section

182 LUT selection and application section

Dv input image

Da LCD data

Db LED data

1. An image display device with a function of controlling backlight luminances, comprising:
a display panel including a plurality of display elements;
temperature detection means for detecting a temperature of the display panel;
a backlight including a plurality of light sources;
a light-emission luminance calculation section for dividing an input image into a plurality of areas and obtaining light-emission luminance data based on the input image, the light-emission luminance data indicating luminances of light sources upon light emission for each corresponding area;
a display data calculation section for obtaining display data to control light transmittances of the display elements, based on the input image and the light-emission luminance data obtained by the light-emission luminance calculation section;
temperature compensation means for calculating correction values to compensate for changes in the light transmittances due to temperature variations, based on the temperature detected by the temperature detection means, and correcting the display data based on the calculated correction values;
a panel driver circuit for outputting to the display panel a signal for controlling the light transmittances of the display elements based on the display data corrected by the temperature compensation means; and
a backlight driver circuit for outputting to the backlight a signal for controlling the luminances of the light sources based on the light-emission luminance data.

2. The image display device according to claim 1, wherein the temperature compensation means includes timing detection means for detecting a time point at which any luminance change that occurs due to correction of the display data is invisible or less visible, and the correction values are calculated at the time point detected by the timing detection means.

3. The image display device according to claim 2, wherein the timing detection means detects a scene change point at which the amount of change of the input image is greater than a predetermined threshold.

4. The image display device according to claim 3, wherein the timing detection means detects as the scene change point at least one of a switch point between video channels on which to provide the input image and a switch point between video display modes representing display formats on the display panel.

5. The image display device according to claim 1, wherein,
the temperature detection means divides a display area of the display panel into a plurality of divided display areas and detects temperatures for the respective divided display areas, and
the temperature compensation means calculates correction values to compensate for the changes in the light transmittances due to temperature variations in the divided display areas, based on the temperatures detected for the respective divided display areas by the temperature detection means, and corrects the display data based on the correction values calculated for the respective divided display areas.

6. The image display device according to claim 1, further comprising:
backlight temperature detection means for detecting a temperature of the backlight; and
backlight temperature compensation means for calculating correction values to compensate for changes in luminances of the light sources due to temperature variations, based on the temperature detected by the backlight temperature detection means, and correcting the light-emission luminance data based on the calculated correction values, wherein,
the backlight driver circuit outputs signals for controlling the luminances of the light sources to the backlight based on the light-emission luminance data corrected by the backlight temperature compensation means.

7. A method for controlling an image display device which has a function of controlling backlight luminances and is provided with a display panel including a plurality of display elements and a backlight including a plurality of light sources, the method comprising:
a temperature detection step of detecting a temperature of the display panel;
a light-emission luminance calculation step of dividing an input image into a plurality of areas and obtaining light-emission luminance data based on the input image, the light-emission luminance data indicating luminances of light sources upon light emission for each corresponding area;
a display data calculation step of obtaining display data to control light transmittances of the display elements, based on the input image and the light-emission luminance data obtained in the light-emission luminance calculation step;
a temperature compensation step of calculating correction values to compensate for changes in the light transmittances due to temperature variations, based on the temperature detected in the temperature detection step, and correcting the display data based on the calculated correction values;
a panel driving step of controlling the display panel in terms of the light transmittances of the display elements based on the display data corrected in the temperature compensation step; and
a backlight driving step of controlling the backlight in terms of the luminances of the light sources based on the light-emission luminance data.
